(19) United States
(12) Patent Application Publication
(10) Pub. No.: US 2026/0232511 A1
(43) Pub. Date: Aug. 13, 2026

(54) Multi-positional, decompression, therapeutic, support pillow

(71) Applicant: Stella Gabrielle BUSTOS, SAN ANTONIO, TX (US)

(72) Inventor: Stella Gabrielle BUSTOS, SAN ANTONIO, TX (US)

(21) Appl. No.: 19/049,416

(22) Filed: Feb. 10, 2025

(51) Int. Cl. A61H 1/02

(52) U.S. Cl. CPC A61H 1/0229; A61H 2201/10

(57) ABSTRACT

Disclosed herein the invention is a medical, therapeutic, wedge-shaped, trapezoidal, support cushion having a semi-circular cut out, that can be used in any crease, crevice or curve throughout the body, to reduce neuromusculoskeletal tension, that when used properly can lead to decreasing dysfunction and increased quality of living. The invention is a medical benefit, comfortable, portable and when used behind the back, neck, buttocks and hip areas, supports realignment of the skeletal body providing an immediate pain point and pressure-relieving effect. As an additional healing benefit, the invention has an embedded generic, mineral crystal, offering deeper healing effects on the body that balances the natural frequency to optimize comfort and positively affect overall health.

### CROSS-REFERENCE TO RELATED APPLICATIONS

Not applicable

### THE NAMES OF THE PARTIES TO AJOINT RESEARCH AGREEMENT

Not applicable

### INCORPORATING-BY-REFERENCE

Not applicable

### SEQUENCE LISTING

Not applicable

### FIELD OF THE INVENTION

The present invention generally relates to a device and method of use for a multi-positional, decompression, therapeutic support pillow. More specifically, the present invention generally relates to a device and methods of use for a multi-positional support pillow for the alleviation of pain.

### BACKGROUND OF THE INVENTION

Without limiting the scope of the disclosed systems and methods, the background is described in connection with novel device and methods of use for a multi-positional support pillow.

One of the most common ailments people suffer is pain, particularly in the lower extremities such as back, neck, hip, and knee pain. Often pain is aggravated while seated. While remedies for such pain relief exist including injections, and pharmaceuticals, there are few effective remedies available that do not require medical supervision or risk of side effects. One such remedy is a therapeutic pillow.

While numerous therapeutic pillows exist that claim the relief of pain in the back, neck, hips and knees, they are restricted to a certain user. Existing devices are limited to be utilized in one position to effectuate pain relief. Additionally, these devices are contoured in a way to only be optimal for a particular sized person.

Current devices primarily ease pain in the user by relieving pressure in the spine or providing neck support. This method may be successful for some users but is not universally ideal for all users and forms of pain.

What is desired, therefore, is a device and method that alleviates pain in a convenient, flexible manner that can be utilized by a multitude of users. By achieving these desires, users can manage pain in a safe and non-pharmaceutical manner.

### BRIEF SUMMARY OF THE INVENTION

Accordingly, it is an object of the present invention to provide a device and method of use for a multi-positional support pillow. It is a further object of the present invention to allow the device and methods of use to be utilized by a multitude of users for numerous ailments.

These and other objects of the present invention are achieved by a device and methods of use for a multi-positional support pillow as herein described.

In an embodiment, the device is comprised of a trapezoidal body composed of a durable foam material. The body contains a semicircle like cutout on the front end of the body for the user to be able to comfortably use the device in a variety of positions. The device has a tapering thickness whereas the back edge is thicker than the front edge. There is also a strap with means of closure attached to the device, which allows it to be secured to various surfaces as may be required by the user. Such means of closure may include hook and loop, buckles, elastic straps and ties.

The device may be placed under the user's leg with the thicker, back edge, facing away from the user's body. The tapered shape allows for the relief of pain by releasing compression, stretching the lower back muscles, and allowing for isometric movement, which increases blood circulation. Unlike existing devices, the unique shape of this device allows for it to be flipped, turned, and re-positioned so the user may achieve the best position for pain relief.

The semicircle cutout allows for even further multi-positional options for the user. For example, the device can be secured so that the semicircle cutout is placed behind the user's neck, providing neck stabilization and restoring the natural curvature of the neck.

In a further embodiment, the device may come in various sizes to allow for even more availability and flexibility for a multitude of users.

In an even further embodiment, the device may have a crystal embedded into the body of the multi-positional support pillow.

In summary, the present invention discloses a novel device and methods of use for securing a multi-positional support pillow.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a front perspective view of the multi-positional support pillow in accordance with embodiments of the disclosure;

FIG. 2 is a front view of the multi-positional support pillow in accordance with embodiment of the disclosure;

FIG. 3 is a back side view of the multi-positional support pillow in accordance with embodiment of the disclosure;

FIG. 4 is a left side view of the multi-positional support pillow in accordance with embodiment of the disclosure;

FIG. 6 is a top side view of the multi-positional support pillow in accordance with embodiment of the disclosure;

FIG. 7 is a bottom side view of the multi-positional support pillow in accordance with embodiment of the disclosure.

FIG. 8 is a back perspective view of the multi-positional support pillow in accordance with embodiment of the disclosure.

### DETAILED DESCRIPTION OF THE INVENTION

Disclosed herein is a novel device and methods of use for multi-positional support pillow.

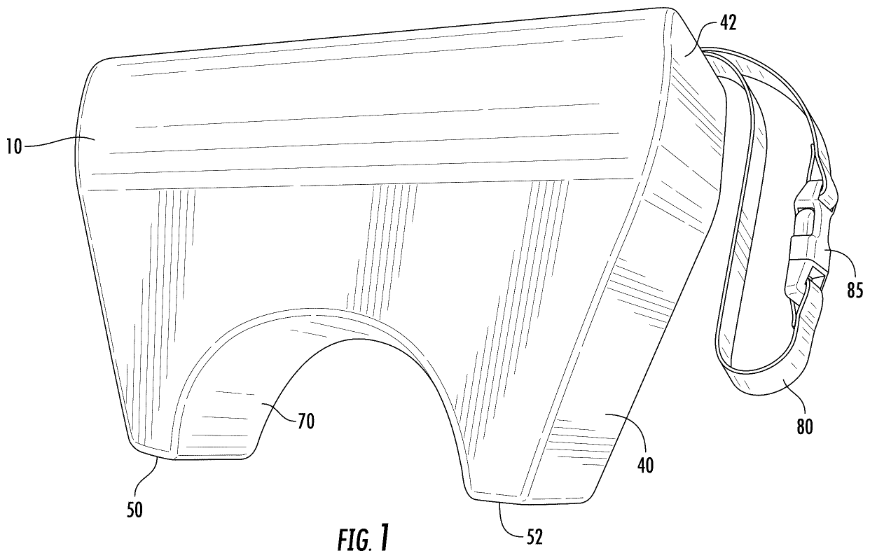

Reference is first made to FIG. 1, a front perspective view of the device in accordance with embodiments of the disclosure. In one embodiment, the device is comprised of a trapezoidal body 10. The front face of the body has two extended portions 50 and 52 and a semicircle cutout 70. Also visible in this illustration is the angled right-side surface 40 and back right surface 42. The angled right-side surface 40 displays the trapezoidal shape of the body of the device. Attached to the device is a strap 80 which is used to secure the device to various surfaces. The strap 80 has means of closure 85 such as a buckle, button, hook and loop closure or other fastening means, to assist in securing or attaching the device. In an embodiment, embedded into the body 10 is a crystal. The crystal utilized may be include but is not limited to Amethyst, Pink Tourmaline, Citrine, Kombaba Jasper, Tiger Eye, and Carnelian. Each crystal that may be utilized is known in the art to possess varying qualities to benefit the user.

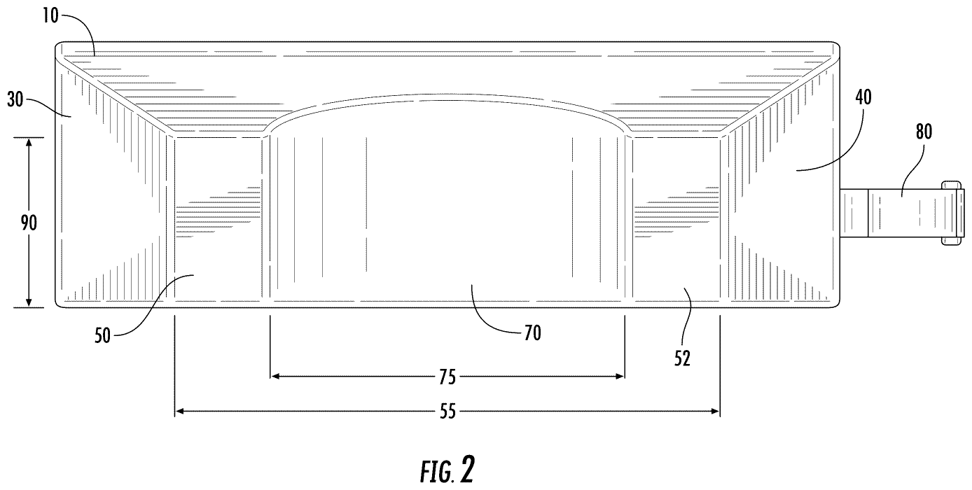

Reference is next made to FIG. 2, a front side view of the device in accordance with embodiments of the disclosure. In an embodiment, the front side displays the left extended portion 50 and the right extended portion 52. The height of the extended portions 90 is less than the height of the back of the body. Centered between the two extended portions is a semicircle cutout 70. The diameter of the semicircle cutout 75 is less than the width of the front side 55 of the device. The semicircle cutout 70 allows for the device to be used in multiple positions including the neck. When the back of the neck is positioned in the semicircle cut-out it allows for the neck to be supported and realigns the neck with its natural curvature permitting for support and relief. Further, the semicircle cutout 70 may be used to help position and secure other pain-stricken extremities such as a leg or knee. Also visible in this illustration are the angled left-side surface 30 and angled right-side surface 40. The strap 80 can also be seen.

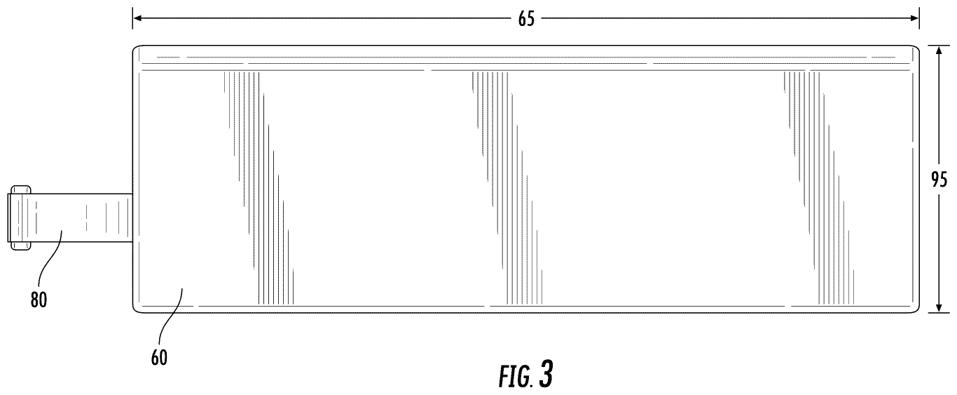

Reference is now made to FIG. 3, a back side view of the device in accordance with embodiments of the disclosure. The strap 80 may be used to secure the device to various surfaces and is attached to the back surface 60. The strap 80 may be used to secure the device to surfaces such as the headrest of a vehicle seat to provide neck support while driving or to the seat of a chair, so the device may be used under the knees, allowing for the lower back muscles to stretch, for proper postural alignment. The height of the back of the device 95 and width of the back of the device 65 are greater than the height and width of the front of the device, consistent with a trapezoidal shape. In an embodiment, the strap may be composed of an elastic material so it may be easily secured to surfaces such as a headrest.

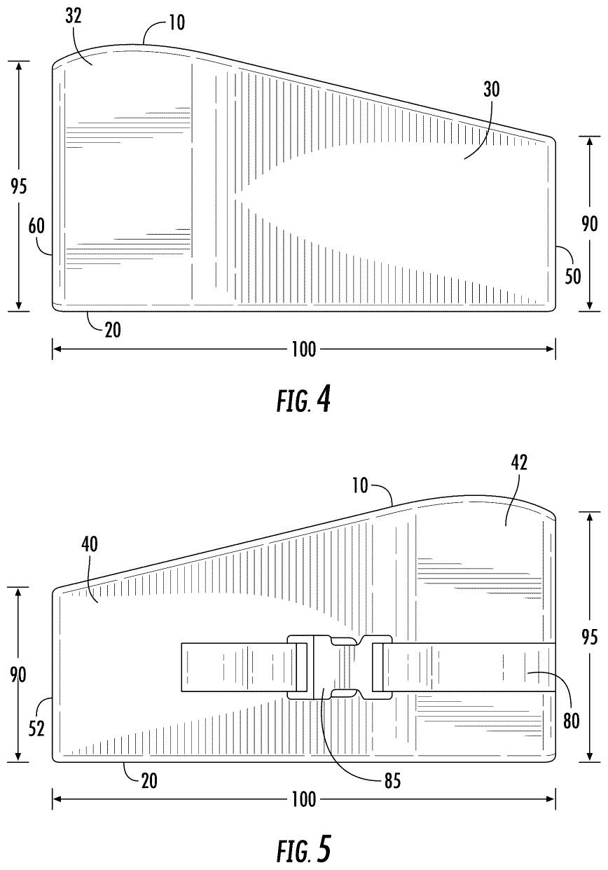

Reference is next made to FIG. 4, a left side view of the device in accordance with embodiment of the disclosure. The back left surface 32 runs perpendicular to the back surface 60. The angled left side surface 30 is sloped inwards from the perpendicular left back surface 32. Further, in this illustration the tapering height of the body is visible. The height of the back side 95 is greater than that of the front side 90. The tapering height of the device creates a unique support for numerous extremities. For example, the device may be placed under the user's leg so that the front side 50 is closest to the user's body and the higher, back side the user's body. This wedge-like support provides pain relief in the user's back by creating increased blood circulation and exercising the hip joint. The bottom surface of the device 20 does not taper so that it sits flat on a surface. An additional position and use of the device would be to place the device under the user's arm so that the front side 50 is again closest to the user's body, providing support for the arm and wrist. This may aid in the alleviation of pain caused by carpal tunnel. The length of the device 100 will allow for various users to utilize the support of the device in numerous positions.

Reference is now made to FIG. 5, a right side view of the device in accordance with embodiments of the disclosure. The strap 80 of the device and means of closure 85 allow for the user to secure the device onto various surfaces for secured support or for attachment to numerous luggage and bags for easy transport. The angled right side surface 40 is sloped inwards from the perpendicular left back surface 42. In this illustration, the distinct wedge-like shape of the device is visible with the height of the back 95 being greater than the height of the front 90.

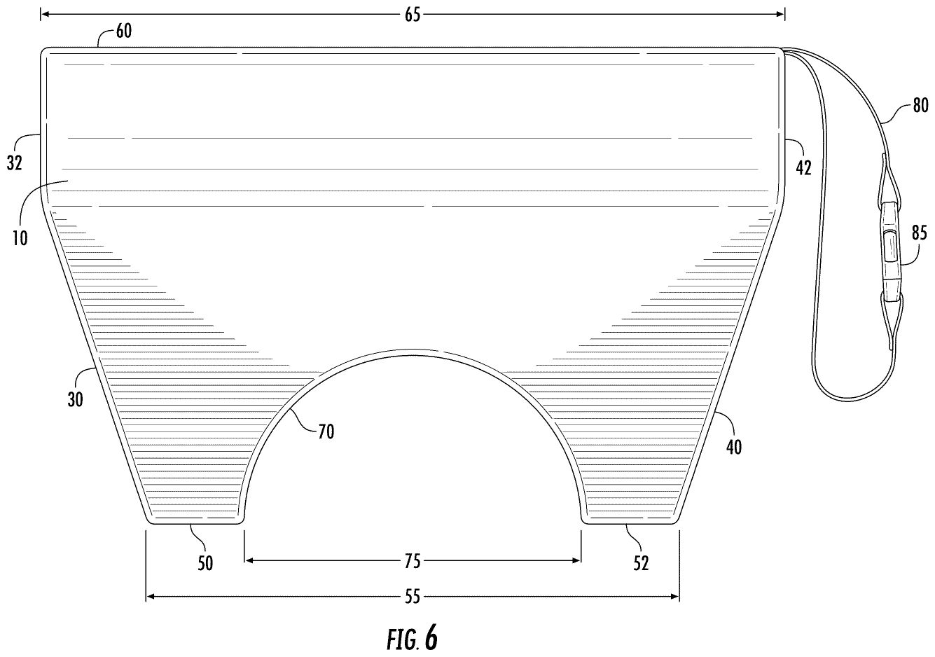

Reference is next made to FIG. 6, a top view of the device in accordance with embodiments of the disclosure. In an embodiment the device has a trapezoidal body 10. This figure illustrates the semicircle cutout 70 centered on the front side of the device. The diameter of the semicircle 75 is less than the width of the front side 55 so that there is a portion of the pillow on either side of the cutout that remains. Further the width of the front side 55 is less than the width of the back side 65, creating the inward tapered angle of the angled left surface 30 and angled right surface 40. The back left surface 32 and back right surface 42 run perpendicular to the back surface 60. In an embodiment the strap 80 is attached to the sides of the device such as the back left surface 32 and/or the back right surface 42. In further embodiment the strap 80 may be attached to the back surface 60 of the device. The strap may also be attached to the back surface 60 and one of the side surfaces. In an even further embodiment, the strap 80 may have varying attachment means on each end of attachment.

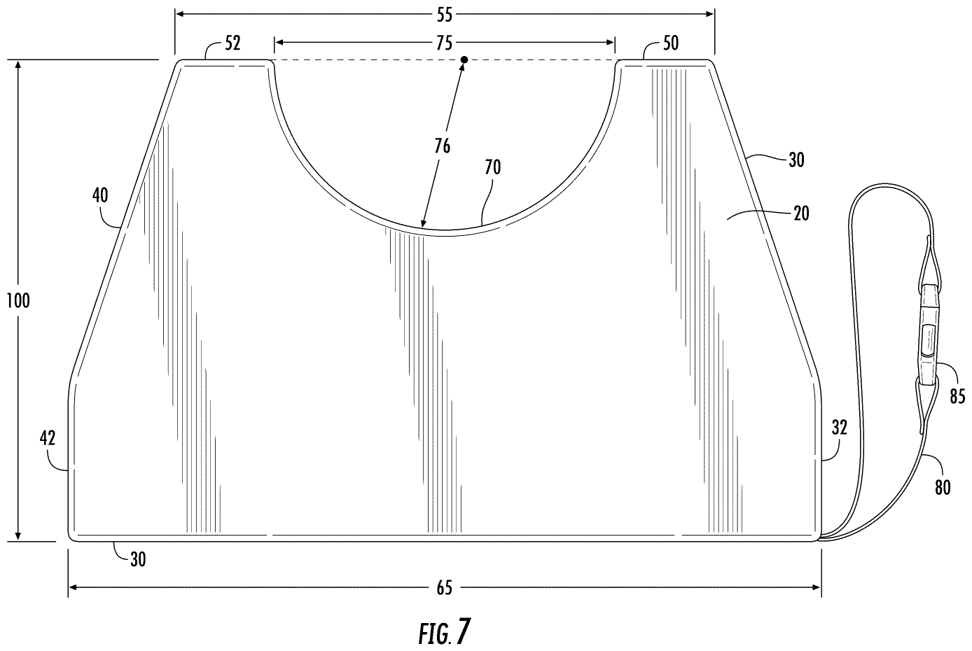

Reference is now made to FIG. 7, a bottom view of the device in accordance with embodiments of the disclosure. The bottom surface of the device 20 does not taper but is straight so it sits flat on the surface on which the device is placed. The radius of the semicircle cutout 76 is less than the length of the body of the device 100.

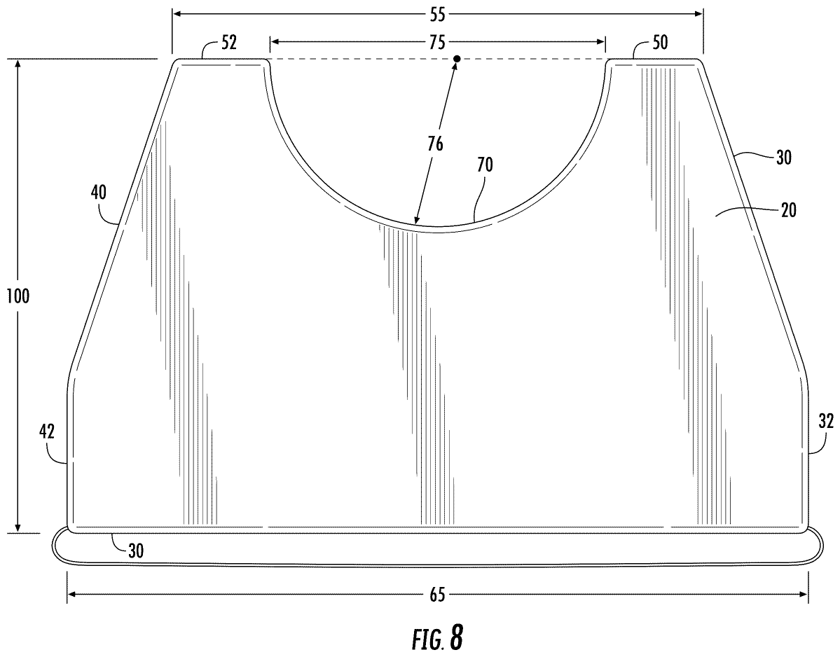

Reference is lastly made to FIG. 8, a back perspective view of the device in accordance with embodiments of the disclosure. In an embodiment the strap 80 is fixed on the left back side 32 and the right back side 42. In a further embodiment the strap 80 is fixed on one end and attaches to the body of the device by means of attachment such as hook and loop, button, buckle, snap, and other attachment means. In an even further embodiment, both ends of the strap 80 may have attachment means so that the strap may be entirely detached from the device. The strap 80 is at least as long as the width of the back side 65 of the device.

In brief, the invention is directed to a device and method of use for a multi-positional support pillow.

The disclosed systems and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”,“an”, and “the” are not intended to refer to only a singular entity, but include the general class of which a specific example may be used for illustration. The terminology herein is used to describe specific embodiments of the invention, but their usage does not delimit the disclosed device or method of use, except as may be outlined in the claims.

Alternative applications for this invention include using the device and methods of use for positioning and providing support and pain relief including decompression and realignment of the spine and neck.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods of use disclosed and claimed herein can be made and executed without undue experimentation in light of the present disclosure. While the systems and methods of this invention have been described in terms of preferred embodiments, it will be apparent to those skilled in the art that variations may be applied to the systems and/or methods in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

1. Description of structure

2. Method Steps of the invention

3. Method of structure and crystal qualities
